(19) United States
(12) Patent Application Publication
(10) Pub. No.: US 2026/0231028 A1
(43) Pub. Date: Aug. 6, 2026

(54) TECHNIQUES FOR LOW-POWER WAKE-UP SIGNALING

(71) Applicant: Lenovo (United States) Inc., Morrisville, NC (US)

(72) Inventors: Karthikeyan Ganesan, Nauheim (DE); Ali Ramadan Ali, Kraiburg am Inn (DE); Ravi Kuchibhotla, Chicago, IL (US)

(21) Appl. No.: 19/047,579

(22) Filed: Feb. 6, 2025

(51) Int. Cl. H04W 52/02; H04L 27/26

(52) U.S. Cl. CPC H04W 52/0235; H04L 27/26414

(57) ABSTRACT

Various aspects of the present disclosure relate to techniques for low-power wake-up signaling. An apparatus is configured to transmit a configuration message for low-power wake up signal (WUS), wherein the configuration message indicates one or more frequency sub-bands associated with transmission of low-power WUS, one or more subgroups within the one or more frequency sub-bands for transmission of low-power WUS, or a combination thereof, and transmit a low-power WUS in accordance with the configuration message.

### TECHNICAL FIELD

The present disclosure relates to wireless communications, and more specifically to techniques for processing (e.g., transmitting, receiving, monitoring, detecting, decoding, encoding) a low-power wake-up signal (WUS).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A network equipment (NE) for wireless communication is described. The NE may be configured to, capable of, or operable to transmit a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and transmit a low-power WUS in accordance with the configuration message.

A processor for wireless communication is described. The processor may be configured to, capable of, or operable to transmit a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and transmit a low-power WUS in accordance with the configuration message.

A method for wireless communication performed by an NE is described. The method may be configured to, capable of, or operable to transmit a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and transmit a low-power WUS in accordance with the configuration message.

A UE for wireless communication is described. The UE may be configured to, capable of, or operable to receive a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and receive a low-power WUS in accordance with the configuration message.

A processor for wireless communication is described. The processor may be configured to, capable of, or operable to receive a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and receive a low-power WUS in accordance with the configuration message.

A method for wireless communication performed by a UE is described. The method may be configured to, capable of, or operable to receive a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and receive a low-power WUS in accordance with the configuration message.

### BRIEF DESCRIPTION OF THE DRAWINGS

FIG. 1 illustrates an example of a wireless communications system, in accordance with aspects of the present disclosure.

FIG. 2 illustrates a flowchart of a method performed by a UE, in accordance with aspects of the present disclosure.

FIG. 3 illustrates an example of transmission of a low-power synchronization signal (SS), in accordance with aspects of the present disclosure.

FIG. 4 illustrates an example of transmission of a low-power SS, in accordance with aspects of the present disclosure.

FIG. 5 illustrates an example of frequency hopping, in accordance with aspects of the present disclosure.

FIG. 6 illustrates an example of frequency hopping, in accordance with aspects of the present disclosure.

FIG. 7 illustrates an example of a UE, in accordance with aspects of the present disclosure.

FIG. 8 illustrates an example of a processor, in accordance with aspects of the present disclosure.

FIG. 9 illustrates an example of a NE, in accordance with aspects of the present disclosure.

FIG. 10 illustrates a flowchart of a method performed by a UE, in accordance with aspects of the present disclosure.

FIG. 11 illustrates a flowchart of a method performed by an NE in accordance with aspects of the present disclosure.

### DETAILED DESCRIPTION

Generally, the present disclosure describes systems, methods, and apparatuses for processing (e.g., transmitting, receiving, monitoring, detecting, decoding, encoding) a low-power WUS. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

A UE may be configured (e.g., equipped) with one or more radios, such as a main radio and one or more secondary radios to manage resources and power saving of the UE. For example, a power-sensitive, small form-factor UE, such as an Internet of Things (IoT) device may be equipped with a low-power radio (LR) that consumes less power than a main radio (MR). The LR may enable the UE to maintain a low-power state while still being able to detect for (e.g., monitor) and process (e.g., receive, decode) incoming transmissions (e.g., signals). For example, a UE may via an LR (also referred to as a low-power wakeup radio (WUR)) of the UE detect a low-power WUS. Some techniques for WUS detection involve use of an envelope detector that processes on-off keying (OOK) waveforms to maximize power savings. However, while envelope detectors offer superior power efficiency compared to in-phase/quadrature-phase (IQ) correlators, these detectors suffer from reduced coverage and reliability, which can negatively impact responsiveness and performance.

The present disclosure generally relates to processing (e.g., monitoring, detecting, receiving, transmitting) a low-power WUS, particularly to one or more configurations for processing low-power WUS in accordance with the one or more configurations to minimize latency while experiencing power saving. By way of example, a base station may transmit, and a UE may receive, a configuration message for low-power WUS. The configuration message may include configuration information that may indicate one or more frequency sub-bands associated with transmission of low-power WUS, one or more subgroups within the one or more frequency sub-bands for transmission of low-power WUS, or a combination thereof.

As used herein, a subgroup may refer to a group of devices, e.g., UEs or IoT devices, that that are designed to be activated by a low-power WUS, allowing them to transition from a sleep mode to an active state while consuming minimal energy. These devices may be configured to monitor paging occasions where the corresponding codepoint of the subgroup that the UE belongs to is indicated by a low-power WUS corresponding to its paging occasion. Thus, a subgroup within a frequency sub-band may be a set of UEs associated with the frequency sub-band.

In some examples, each of the one or more frequency sub-bands, each of the one or more subgroups within the one or more frequency sub-bands, or a combination thereof may correspond to a codepoint. The UE may be configured to low-power WUS in accordance with the codepoint. The base station may transmit the low-power WUS, and the UE may detect (e.g., monitor for) and receive the low-power WUS in accordance with the configuration information.

As described herein, by enabling the NE and the UE to process (e.g., monitor, detect, receive, transmit) a low-power WUS, particularly in accordance with one or more configurations (e.g., codepoints) for processing low-power WUS, the UE may experience improved wake-up times, overall power saving (e.g., increased battery life), improved selectivity in wake-up signal detection, and optimized resource utilization. In this manner, battery life and operational efficiencies in power-sensitive devices such as UEs and IoT devices can be enhanced.

Aspects of the present disclosure are described in the context of a wireless communications system. Note that one or more aspects from different solutions may be combined.

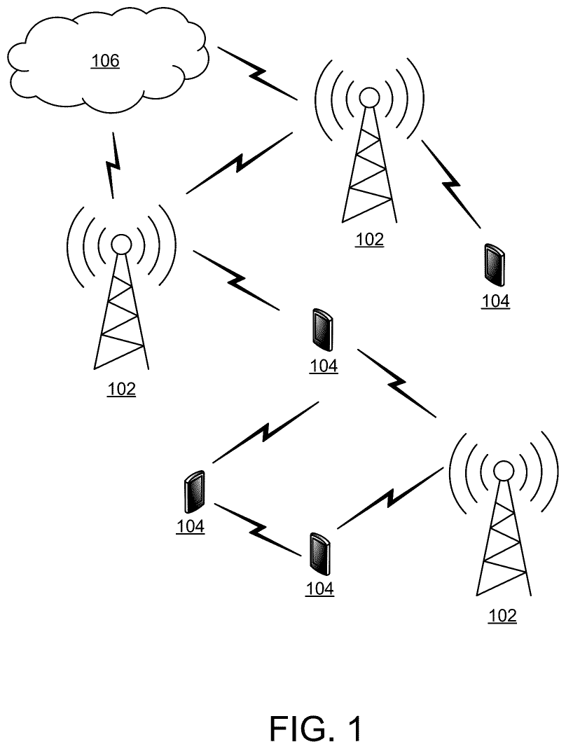

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communication systems may include one or more power-sensitive, small form-factor devices, such as a UE (e.g., an IoT device) that may be equipped with a LR that consumes less power than an MR of the UE. In some implementations, the UE may use an LR to monitor for a low-power WUS. In some cases, the LR may implement power saving and coverage enhancement using an envelope detector that receives an OOK waveform. The envelop detector-based approach maximizes power saving gains compared to the IQ correlator; however, the coverage enhancement (e.g., coverage range) of the envelop detector-based receiver is more limited compared to the IQ correlator-based receiver.

Overlaid OFDM sequences (e.g., OFDM sequences that are combined with other sequences to improve sensing capabilities) may be used for low-power WUS, such as sequences for OOK-1 and OOK-4 with M=1, and may refer to sequences of an OOK signal on a symbol before Discrete Fourier Transform (DFT) and/or least squares (LS) processing, where the DFT size is 2ⁿ. In such cases, Zadoff-Chu (ZC) sequencing is applied in the time domain, followed by DFT and/or LS, and then an inverse discrete Fourier transform (IFFT) to generate a sequence in a frequency domain that either corresponds to a ZC sequence or approximates a ZC sequence. It is noted that this operation does not preclude additional processing for OOK-4 with M>1. Additionally, it is noted that OOK-1 is considered a specific case of OOK-4 with M=1.

In some cases, OOK-4 supports transforming an M-bit OOK signal in the time domain. In such cases, N split channels (SCs) of OOK-1 are generated using a transformation, such as DFT and/or LS. To produce M OOK bits per OFDM symbol, N′ samples are generated from the M-bit OOK signal. Signal modification, including truncation or other adjustments, may be selectively applied. If no modification occurs, N remains equal to N′. In some cases, N′ may also correspond to K, where K represents the size of the IFFT. By way of example, for multiple carrier-amplitude shift keying (MC-ASK) waveform generation, where K is the size of the IFFT used in cyclic prefix OFD multiple access (CP-OFDMA), the number of SCs allocated for low-power WUS, including potential guard-bands, is represented by N. In some other cases, for a single-bit transmission within an OFDM symbol, the SCs of the low-power WUS is as follows: when OOK=1, all SCs are modulated, when OOK=0, all SCs exhibit zero power from a baseband perspective.

In one case, for overlaid OFDM sequences for low-power WUS, there are several different options. In a first embodiment, a single overlaid sequence is on each OOK ‘ON’ symbol or OFDM symbol duration. In another case, OFDM-based LR can obtain the whole information bits by the presence of the overlaid sequence. In some other cases, the overlaid OFDM sequence is pre-determined from multiple sequences. This sequence may not carry any information bits of low-power WUS. In one case, OFDM-based LR can obtain the information bits associated with the OOK ON/OFF pattern.

In one case, a sequence is selected from multiple candidates for overlaid OFDM sequences on each OOK ‘ON’ symbol or OFDM symbol duration, and OFDM-based LR may obtain low-power WUS information associated with overlaid OFDM sequence(s). Further, in some cases, the overlaid OFDM sequence(s) carry portions of information bits of low-power WUS. In other cases, OFDM-based LR obtains the information bits by OFDM sequence(s) and location of the OFDM sequence(s) or OOK symbols. In another case, the overlaid OFDM sequence(s) carry information bits of low-power WUS. OFDM-based LR may obtain the information bits by the overlaid OFDM sequence(s).

In one case, one sequence is selected from multiple candidates of overlaid OFDM sequences on one or more OOK ‘ON’ symbols, and OFDM-based LR may obtain low-power WUS information from overlaid OFDM sequence(s). In one case where modulated overlay sequences with constellation points are used, overlay sequence may act as a spreading sequence and constellation point that carries information for OFDM-based LR.

In some cases, various codepoints are supported for low-power WUS. For instance, one codepoint may correspond to each of the subgroups that can be indicated by low-power WUS. In another case, one codepoint may correspond to all the subgroups that can be indicated by low-power WUS. In one case, UEs that monitor the same or different paging occasions can be divided into one or more subgroups. As used herein, subgroups or subgrouping may refer to groups of UEs that monitor paging occasions where the corresponding codepoint of the subgroup that the UE belongs to is indicated by low-power WUS corresponding to its paging occasion.

In one case, when the number low-power WUS monitoring occasions (K) is configured for each beam associated with a low-power WUS occasion (also associated with a local oscillator), down selection may be performed. For instance, in one case, K low-power WUS monitoring occasions for a beam may be divided into M groups (where M>=1) of R low-power WUS monitoring occasions. A UE may monitor all or some of the monitoring occasions within the K low-power WUS monitoring occasions. In one case, for each group of R low-power WUS monitoring occasions, the same low-power WUS information is transmitted. In other cases, different low-power WUS information can be transmitted in different groups of R low-power WUS monitoring occasions.

In one case, K low-power WUS monitoring occasions for a beam are divided into G groups (where G>=1) of R*M (where M>=1) low-power WUS monitoring occasions. A UE may monitor all or some of the monitoring occasions within one group of R*M low-power WUS monitoring occasions based on its subgroup ID. In one case, each group of R*M low-power monitoring occasions is further divided into M groups of R low-power WUS monitoring occasions. In one case, for each group of R low-power WUS monitoring occasions, the same low-power WUS information is transmitted. In another case, different low-power WUS information can be transmitted in different groups of R low-power WUS monitoring occasions.

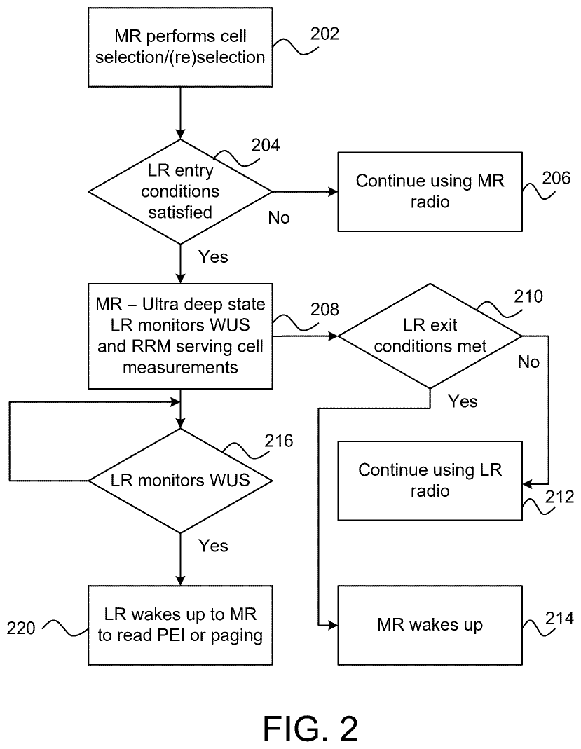

FIG. 2 illustrates a flowchart of a method performed by a UE in accordance with aspects of the present disclosure. In some examples, the method may implement or is implemented by aspects of the wireless communications system 100. For example, the method may implement or be implemented by a UE 104, which may be examples of the corresponding devices as described with reference to FIG. 1. Alternative examples of the following may be implemented, where some operations and/or signaling are performed in a different order than described or are not performed. In some cases, some operations and/or signaling may include additional features not mentioned below, or further operations and/or signaling may be added.

The UE may be configured (e.g., equipped) with one or more radios, such as a main radio and one or more secondary radios to manage resources and power saving of the UE. For example, the UE may be equipped with an MR and at least one LR that consumes less power than the MR. The MR of the UE may power ON (e.g., wake up) and perform one or more operations. For example, at 202, the MR of the UE may perform one or more of cell selection or cell re-selection.

In one embodiment, the MR of the UE may perform frequency raster synchronization in case there are no previously stored cells and/or checks the frequency corresponding to the previously stored cell. As part of the synchronization procedure, the MR receives synchronization signal blocks (SSBs) from the cell and performs SSB measurements of one or more cells.

In one embodiment, once the MR selects the cell with the best received SSB according to the received reference signal received power (RSRP), reference signal received quality (RSRQ), received signal strength indicator (RSSI), or the like, then the UE may proceed to read the control resource set (CORESET) #0 and system information block (SIB) #1 from that cell and determines whether the cell is barred or not for communication. If the cell is barred, then the MR performs cell re-selection and finds another cell.

In one embodiment, the MR evaluates 204 the entry condition for LR, e.g., by checking the RSRP of the SSB. In one embodiment, if the LR entry condition is satisfied (Yes as 204), e.g., if the entry condition is above certain threshold, then the method continues to step 208. Otherwise, if the entry condition is not satisfied (No at 204), e.g., if the entry condition is below a certain threshold, then the method continues 206 using the MR radio.

In response to determining that the entry condition is satisfied, in one embodiment, while the MR is in an ultra-deep sleep state or deep sleep state, the LR monitors 208 for a low-power WUS and performs idle mode radio resource management (RRM) measurement for the serving cell by monitoring low-power SS. In one embodiment, the UE determines whether an exit condition for the LR is met (Yes at 210), e.g., based on the measurements. If an exit condition is met (Yes at 210), then the MR wakes up 214; otherwise, if the exit condition is not met (No at 210), then the LR continues 212 to be used to monitor for low-power WUS.

In one embodiment, the LR monitors 216 for low-power WUS, and if the LR detects a low-power WUS (Yes at 216) (e.g., in one of the codepoints for a subgroup that a UE is configured to monitor), the LR wakes 220 the MR, and the MR monitors 220 paging messages in its configured paging occasion. Otherwise, the LR continues to monitor 216 for the low-power WUS.

According to a first embodiment of the solution, each UE may monitor two codepoints, where one codepoint corresponds to each of the subgroups that can be indicated by low-power WUS while another codepoint corresponds to all the subgroups that can be indicated by low-power WUS resources. In one embodiment, UEs that monitor the same paging occasion can be divided into one or more subgroups. Or UEs that monitor different paging occasions can be divided into one or more subgroups. With subgrouping, the UE monitors the associated paging occasion if the corresponding codepoint of the subgroup that the UE belongs to is indicated by a low-power WUS corresponding to its paging occasion.

In one embodiment, a plurality of frequency sub-bands in a carrier, bandwidth part (BWP), in a cell, or the like is configured to receive low-power WUS to minimize the latency for the low-power WUS transmission. In one embodiment, the system information may provide, explicitly or implicitly, the mapping between the low-power WUS subgroup and the low-power WUS frequency sub-bands. The gNB may configure the codepoint corresponding to each of the subgroups in one of the low-power WUS frequency sub-bands. Thus, the LR of a UE may be configured to monitor a codepoint in one of the frequency sub-bands according to its subgroup ID that it belongs to. The UE may determine/calculate a subgroup ID according to its International Mobile Subscriber Identity (IMSI) number and the maximum number of subgroups configured per paging occasion.

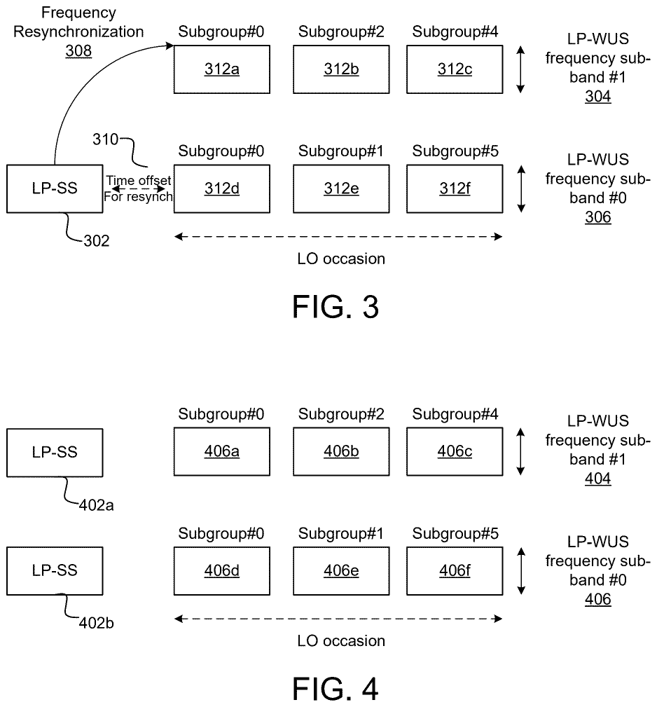

FIG. 3 illustrates an example of transmission of a low-power SS, in accordance with aspects of the present disclosure. In one embodiment, a low-power SS 302 may be transmitted in subgroups 312a-f of one of the low-power WUS frequency sub-bands 304, 306. In such an embodiment, the gNB may inform the MR, using a system information block (SIB), of the frequency sub-band 304, 306 and resource for the low-power SS 302 transmission. In the case where the LR receives the low-power SS 302 and low-power WUS containing the codepoint in different frequency sub-bands 304, 306, the LR of the UE may need to do frequency (re)synchronization 308 between the low-power SS 302 and low-power WUS reception. The time taken for the frequency (re)synchronization 308 should be factored to calculate the time offset 310 between the low-power SS 302 and low-power WUS resources. For example, the capability signaling of the UE may indicate the frequency (re)synchronization timing or one of the plurality of values for the (re)synchronization timing to the gNB.

FIG. 4 illustrates an example of transmission of a low-power SS, in accordance with aspects of the present disclosure. In one embodiment, the low-power SS 402a, 402b may be repeated in subgroups 406a-f of a plurality of the low-power WUS frequency sub-bands 404, 406 (based on a repetition factor) so that the LR may not need to do the frequency (re)synchronization to receive low-power SS 402a, 402b and low-power WUS in different frequency sub-bands 404, 406. The low-power SS 402a, 402b may be transmitted in a plurality of low-power WUS frequency sub-bands 404, 406 at the same time or may be transmitted at different time instances in non-overlapping frequency sub-bands 404, 406.

In one embodiment, the codepoint corresponding to all the subgroups indicated by low-power WUS can be repeatedly transmitted in both the low-power WUS frequency sub-bands so that the LR does not need to do frequency (re)synchronization to read a codepoint corresponding to all subgroups and codepoint corresponding to its own subgroup.

In one embodiment, the codepoint corresponding to all the subgroups indicated by the low-power WUS can be transmitted in one of the plurality of low-power WUS frequency sub-bands. In such an embodiment, the LR of the UE may need to do frequency (re)synchronization to monitor the codepoint for all subgroups and the codepoint for its subgroup. The gNB may indicate to the UE, using SIB signaling, information related to the frequency sub-band and resources that indicate when and where to monitor the codepoint for all subgroups.

In an example embodiment, the low-power WUS subgroup ID configuration between frequency sub-bands may be determined where the gNB configures monitoring occasions with a codepoint that corresponds to each of the subgroups in one of the low-power WUS frequency sub-bands by mapping the time and frequency (e.g., in a time first, frequency second manner, or vice versa). The ascending order of the subgroup ID is mapped to the corresponding time and frequency (e.g., in the time first, frequency second manner or the frequency first, time second manner). The monitoring occasions may include a repetition of the codepoint or a repetition may span across multiple codepoints (e.g., based on a repetition factor).

In another example, the low-power WUS subgroup ID configuration between frequency sub-bands may be determined according to a formula that can be used to derive the mapping between the monitoring occasions in one of the low-power WUS frequency sub-bands to the codepoint that corresponds to each of the subgroups. The formula may take into consideration the number of frequency sub-bands and may map the UE to one of the frequency sub-bands. One example is shown as follows:

$$b = floor ( UE\_ID / B ) mod B$$

$$SubgroupID = ( floor ( UE\_ID - B * b / B * ( N * Ns ) ) mod subgroupsNumForUEID ) + ( subgroupsNumPerPO - subgroupsNumForUEID )$$

where N is the number of total paging frames in T, which is the DRX cycle of RRC_IDLE state, B is the number of total low-power WUS frequency sub-bands in a cell, Ns is the number of paging occasions for a PF, UE_ID is the 5G-S-TMSI mod X, where X is 32768, if eDRX is applied; otherwise, X is 8192, and subgroupsNumForUEID is the number of subgroups for UE_ID based subgrouping in a PO, which is broadcasted in system information.

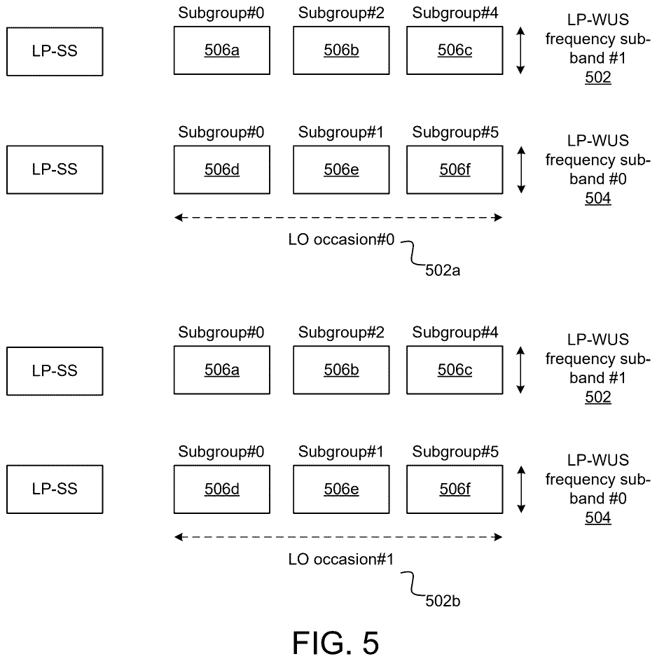

FIG. 5 illustrates an example of frequency hopping, in accordance with aspects of the present disclosure. In one embodiment, frequency hopping is applicable for multiple LOs and to each respective codepoint for each subgroup of the one or more subgroups on a per-LO occasion. In one embodiment, inter-LO frequency hopping can be configured per LO 502a, 502b, such that the codepoint corresponding to each subgroup 506a-f can be hopped between the low-power WUS frequency sub-bands 502, 504 per LO 502a, 502b.

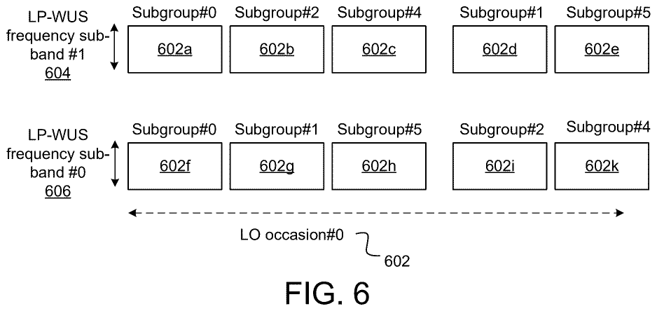

FIG. 6 illustrates an example of frequency hopping, in accordance with aspects of the present disclosure. In one embodiment, frequency hopping is performed on a per-LO basis, is applicable to each respective codepoint for each subgroup of the one or more subgroups, and occurs in respective frequency sub-bands of the one or more frequency sub-bands associated with each subgroup of the one or more subgroups. In another embodiment, intra-LO frequency hopping can be configured, such that the codepoint corresponding to each subgroup 602a-k can be repeated within the LO 602, but in different frequency sub-bands 604, 606.

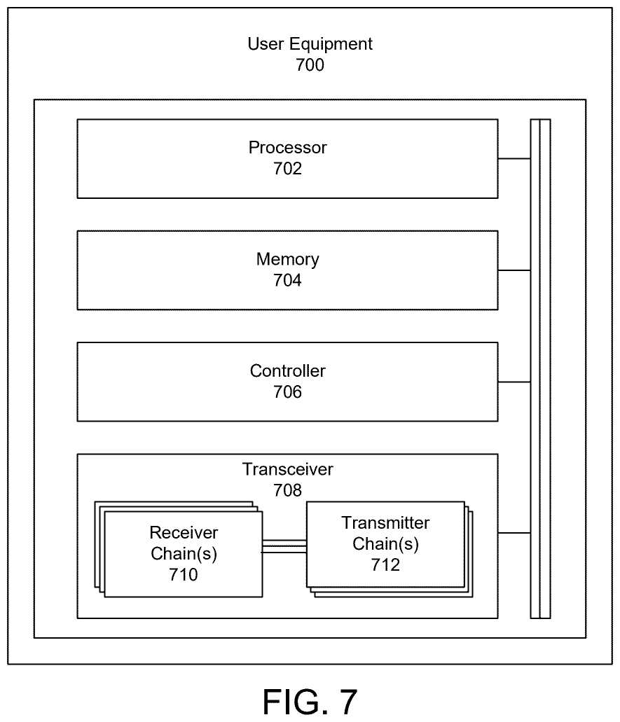

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the UE functions described herein (e.g., executing, by the processor 702, instructions stored in the memory 704). Accordingly, the processor 702 may support wireless communication at the UE 700 in accordance with examples as disclosed herein.

In one embodiment, the UE 700 may be configured to receive a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and receive a low-power WUS in accordance with the configuration message.

In one embodiment, the UE 700 may be configured to receive a configuration for monitoring a codepoint corresponding to each of one or more subgroups in one or more frequency sub-bands associated with transmission of a low-power WUS, detect a low-power WUS on the codepoint according to the configuration, and monitor paging messages in response to the low-power WUS.

In one embodiment, the UE 700 is configured to determine a subgroup identifier for each of the one or more subgroups that comprises the codepoint based on the configuration. In one embodiment, the UE 700 is configured to determine the subgroup identifier based on an international mobile subscriber identity and a maximum number of subgroups that are configured per paging occasion.

In one embodiment, the UE 700 is configured to perform frequency synchronization between low-power WUS and low-power SS reception in response to the low-power SS and the codepoint corresponding to each of the one or more subgroups being received in different frequency sub-bands. In one embodiment, the low-power SS is repeated in a plurality of the one or more frequency sub-bands.

In one embodiment, the codepoint corresponding to each of the one or more subgroups is repeatedly received in each of the one or more frequency sub-bands. In one embodiment, the codepoint corresponding to each of the one or more subgroups is received in one of the one or more frequency sub-bands. In one embodiment, the UE 700 is configured to perform frequency synchronization to detect the codepoint for each of the one or more subgroups.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

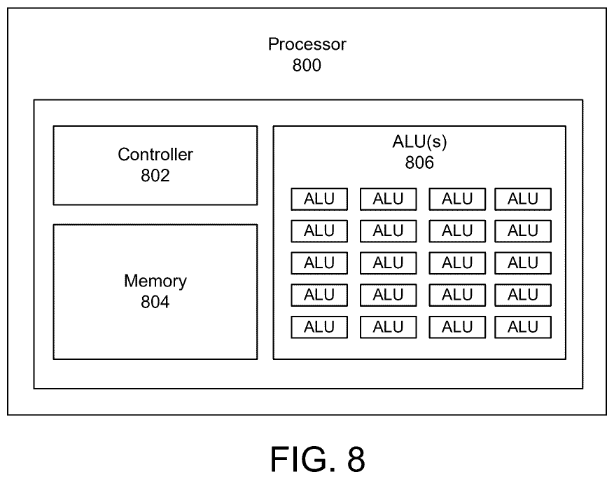

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

In various embodiments, the processor 800 may support wireless communication of a UE, in accordance with examples as disclosed herein. In other embodiments, the processor 800 may support wireless communication of a RAN entity, in accordance with examples as disclosed herein.

In one embodiment, the processor 800 may be configured to transmit a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and transmit a low-power WUS in accordance with the configuration message.

In one embodiment, each subgroup of the one or more subgroups corresponds to a respective codepoint. In one embodiment, the processor 800 is configured to transmit the respective codepoint for each subgroup of the one or more subgroups based at least in part on a repetition factor.

In one embodiment, the processor 800 is configured to transmit the respective codepoint for each subgroup of the one or more subgroups in a respective frequency sub-band of the one or more frequency sub-bands. In one embodiment, the processor 800 is configured to transmit system information for monitoring one or more codepoints associated with the one or more frequency sub-bands associated with transmission of low-power WUS, the one or more subgroups within the one or more frequency sub-bands for transmission of low-power WUS, or a combination thereof.

In one embodiment, the processor 800 is configured to transmit a low-power SS associated with the low-power WUS in a respective frequency sub-band of the one or more frequency sub-bands. In one embodiment, the processor 800 is configured to transmit system information for monitoring the low-power SS, wherein the system information indicates the respective frequency sub-band of the one or more frequency sub-bands and respective resources associated with transmission of the low-power SS.

In one embodiment, the processor 800 is configured to transmit the low-power SS in multiple frequency sub-bands based at least in part on a repetition factor. In one embodiment, the processor 800 is configured to transmit the low-power WUS based at least in part on a frequency hopping, wherein the frequency hopping is applicable for multiple local oscillators, and wherein the frequency hopping is applicable to each respective codepoint for each subgroup of the one or more subgroups on a per-local oscillator occasion.

In one embodiment, the processor 800 is configured to transmit the low-power WUS based at least in part on a frequency hopping, wherein the frequency hopping is on a per-local oscillator basis, and wherein the frequency hopping is applicable to each respective codepoint for each subgroup of the one or more subgroups and occurs in respective frequency sub-bands of the one or more frequency sub-bands associated with each subgroup of the one or more subgroups.

In one embodiment, the processor 800 may be configured to receive a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and receive a low-power WUS in accordance with the configuration message.

In one embodiment, the processor 800 may be configured to receive a configuration for monitoring a codepoint corresponding to each of one or more subgroups in one or more frequency sub-bands associated with transmission of a low-power WUS, detect a low-power WUS on the codepoint according to the configuration, and monitor paging messages in response to the low-power WUS.

In one embodiment, the processor 800 is configured to determine a subgroup identifier for each of the one or more subgroups that comprises the codepoint based on the configuration. In one embodiment, the processor 800 is configured to determine the subgroup identifier based on an international mobile subscriber identity and a maximum number of subgroups that are configured per paging occasion.

In one embodiment, the processor 800 is configured to perform frequency synchronization between low-power WUS and low-power SS reception in response to the low-power SS and the codepoint corresponding to each of the one or more subgroups being received in different frequency sub-bands. In one embodiment, the low-power SS is repeated in a plurality of the one or more frequency sub-bands.

In one embodiment, the codepoint corresponding to each of the one or more subgroups is repeatedly received in each of the one or more frequency sub-bands. In one embodiment, the codepoint corresponding to each of the one or more subgroups is received in one of the one or more frequency sub-bands. In one embodiment, the processor 800 is configured to perform frequency synchronization to detect the codepoint for each of the one or more subgroups.

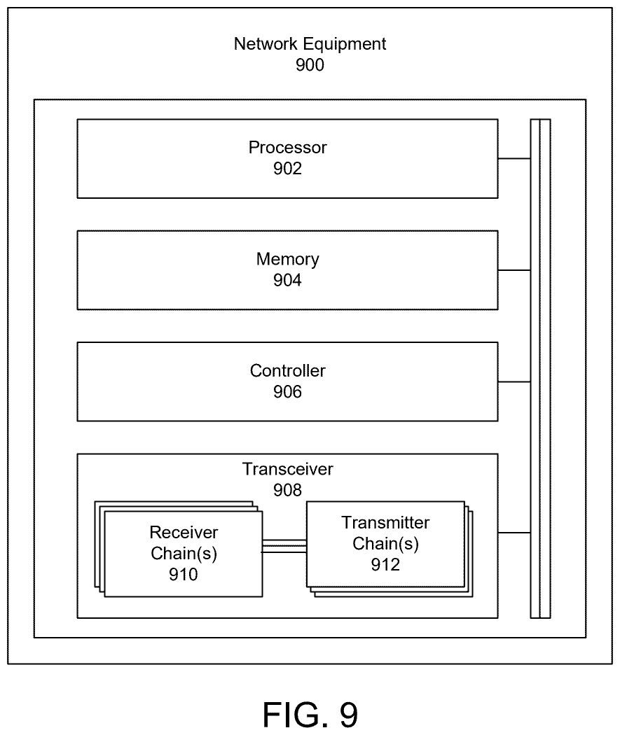

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the RAN functions described herein (e.g., executing, by the processor 902, instructions stored in the memory 904). For example, the processor 902 may support wireless communication at the NE 900 in accordance with examples as disclosed herein.

In one embodiment, the NE 900 may be configured to transmit a configuration message for low-power WUS, wherein the configuration message indicates one or more frequency sub-bands associated with transmission of low-power WUS, one or more subgroups within the one or more frequency sub-bands for transmission of low-power WUS, or a combination thereof, and transmit a low-power WUS in accordance with the configuration message.

In one embodiment, each subgroup of the one or more subgroups corresponds to a respective codepoint. In one embodiment, the NE 900 is configured to transmit the respective codepoint for each subgroup of the one or more subgroups based at least in part on a repetition factor.

In one embodiment, the NE 900 is configured to transmit the respective codepoint for each subgroup of the one or more subgroups in a respective frequency sub-band of the one or more frequency sub-bands. In one embodiment, the processor 800 is configured to transmit system information for monitoring one or more codepoints associated with the one or more frequency sub-bands associated with transmission of low-power WUS, the one or more subgroups within the one or more frequency sub-bands for transmission of low-power WUS, or a combination thereof.

In one embodiment, the NE 900 is configured to transmit a low-power SS associated with the low-power WUS in a respective frequency sub-band of the one or more frequency sub-bands. In one embodiment, the NE 900 is configured to transmit system information for monitoring the low-power SS, wherein the system information indicates the respective frequency sub-band of the one or more frequency sub-bands and respective resources associated with transmission of the low-power SS.

In one embodiment, the NE 900 is configured to transmit the low-power SS in multiple frequency sub-bands based at least in part on a repetition factor. In one embodiment, the NE 900 is configured to transmit the low-power WUS based at least in part on a frequency hopping, wherein the frequency hopping is applicable for multiple local oscillators, and wherein the frequency hopping is applicable to each respective codepoint for each subgroup of the one or more subgroups on a per-local oscillator occasion.

In one embodiment, the NE 900 is configured to transmit the low-power WUS based at least in part on a frequency hopping, wherein the frequency hopping is on a per-local oscillator basis, and wherein the frequency hopping is applicable to each respective codepoint for each subgroup of the one or more subgroups and occurs in respective frequency sub-bands of the one or more frequency sub-bands associated with each subgroup of the one or more subgroups.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

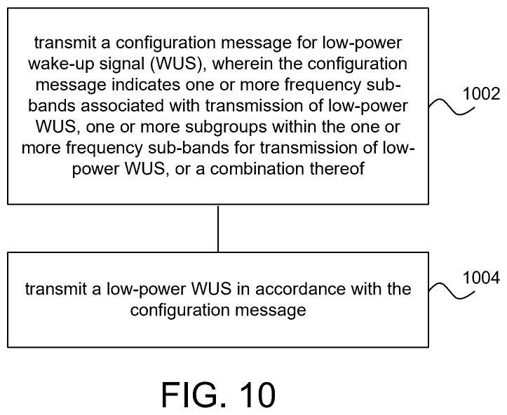

FIG. 10 illustrates a flowchart of a method performed by a NE 900 in accordance with aspects of the present disclosure. The operations of the method 1000 may be implemented by a NE 900 as described herein. In some implementations, the NE 900 may execute a set of instructions to control the function elements of the NE 900 to perform the described functions.

At step 1002, the method may transmit a configuration message for low-power WUS, wherein the configuration message indicates one or more frequency sub-bands associated with transmission of low-power WUS, one or more subgroups within the one or more frequency sub-bands for transmission of low-power WUS, or a combination thereof. The operations of step 1002 may be performed in accordance with examples as described herein. In some implementations, aspects of the operations of step 1002 may be performed by a NE 900, as described with reference to FIG. 9.

At step 1004, the method may transmit a low-power WUS in accordance with the configuration message. The operations of step 1004 may be performed in accordance with examples as described herein. In some implementations, aspects of the operations of step 1004 may be performed by a NE 900, as described with reference to FIG. 9.

It should be noted that the method described herein describes one possible implementation, and that the operations and the steps may be rearranged or otherwise modified and that other implementations are possible.

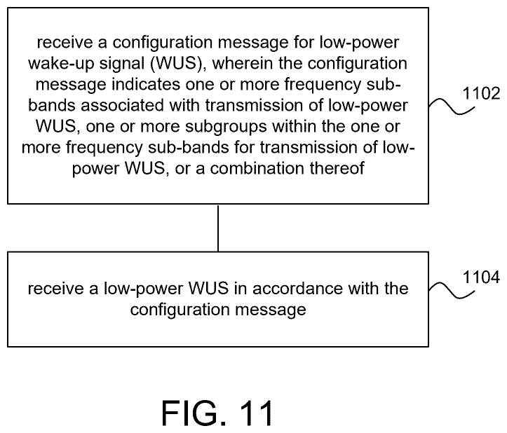

FIG. 11 illustrates a flowchart of a method performed by a UE 700 in accordance with aspects of the present disclosure. The operations of the method may be implemented by a UE 700 as described herein. In some implementations, the UE 700 may execute a set of instructions to control the function elements of the UE 700 to perform the described functions.

At step 1102, the method may receive a configuration message for low-power WUS, wherein the configuration message indicates one or more frequency sub-bands associated with transmission of low-power WUS, one or more subgroups within the one or more frequency sub-bands for transmission of low-power WUS, or a combination thereof. The operations of step 1102 may be performed in accordance with examples as described herein. In some implementations, aspects of the operations of step 1102 may be performed by a UE 700, as described with reference to FIG. 7.

At step 1104, the method may receive a low-power WUS in accordance with the configuration message. The operations of step 1104 may be performed in accordance with examples as described herein. In some implementations, aspects of the operations of step 1104 may be performed by a UE 700, as described with reference to FIG. 7.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and configured to cause the NE to:
transmit a configuration message for low-power wake-up signal (WUS), wherein the configuration message indicates one or more frequency sub-bands associated with transmission of low-power WUS, one or more subgroups within the one or more frequency sub-bands for transmission of low-power WUS, or a combination thereof; and
transmit a low-power WUS in accordance with the configuration message.

2. The NE of claim 1, wherein each subgroup of the one or more subgroups corresponds to a respective codepoint.

3. The NE of claim 2, wherein the at least one processor is configured to cause the NE to transmit the respective codepoint for each subgroup of the one or more subgroups based at least in part on a repetition factor.

4. The NE of claim 3, wherein the at least one processor is configured to cause the NE to transmit the respective codepoint for each subgroup of the one or more subgroups in a respective frequency sub-band of the one or more frequency sub-bands.

5. The NE of claim 4, wherein the at least one processor is configured to cause the NE to transmit system information for monitoring one or more codepoints associated with the one or more frequency sub-bands associated with transmission of low-power WUS, the one or more subgroups within the one or more frequency sub-bands for transmission of low-power WUS, or a combination thereof.

6. The NE of claim 1, wherein the at least one processor is configured to cause the NE to transmit a low-power synchronization signal (SS) associated with the low-power WUS in a respective frequency sub-band of the one or more frequency sub-bands.

7. The NE of claim 6, wherein the at least one processor is configured to cause the NE to transmit system information for monitoring the low-power SS, wherein the system information indicates the respective frequency sub-band of the one or more frequency sub-bands and respective resources associated with transmission of the low-power SS.

8. The NE of claim 6, wherein the at least one processor is configured to cause the NE to transmit the low-power SS in multiple frequency sub-bands based at least in part on a repetition factor.

9. The NE of claim 1, wherein the at least one processor is configured to cause the NE to transmit the low-power WUS based at least in part on a frequency hopping, wherein the frequency hopping is applicable for multiple local oscillators, and wherein the frequency hopping is applicable to each respective codepoint for each subgroup of the one or more subgroups on a per-local oscillator occasion.

10. The NE of claim 1, wherein the at least one processor is configured to cause the NE to transmit the low-power WUS based at least in part on a frequency hopping, wherein the frequency hopping is on a per-local oscillator basis, and wherein the frequency hopping is applicable to each respective codepoint for each subgroup of the one or more subgroups and occurs in respective frequency sub-bands of the one or more frequency sub-bands associated with each subgroup of the one or more subgroups.

11. A method of a network equipment (NE), comprising:
transmitting a configuration message for low-power wake-up signal (WUS), wherein the configuration message indicates one or more frequency sub-bands associated with transmission of low-power WUS, one or more subgroups within the one or more frequency sub-bands for transmission of low-power WUS, or a combination thereof; and
transmitting a low-power WUS in accordance with the configuration message.

12. A user equipment (UE) for wireless communication, comprising:
at least one memory; and
at least one processor coupled with the at least one memory and configured to cause the UE to:
receive a configuration message for low-power wake-up signal (WUS), wherein the configuration message indicates one or more frequency sub-bands associated with transmission of low-power WUS, one or more subgroups within the one or more frequency sub-bands for transmission of low-power WUS, or a combination thereof; and
receive a low-power WUS in accordance with the configuration message.

13. The UE of claim 12, wherein the at least one processor is configured to determine a subgroup identifier for each of the one or more subgroups that comprises a codepoint based on the configuration message.

14. The UE of claim 13, wherein the at least one processor is configured to determine the subgroup identifier based on an international mobile subscriber identity and a maximum number of subgroups that are configured per paging occasion.

15. The UE of claim 12, wherein at least one processor is configured to cause the UE to perform frequency synchronization between low-power WUS and low-power synchronization signal (SS) reception in response to the low-power SS and a codepoint corresponding to each of the one or more subgroups being received in different frequency sub-bands.

16. The UE of claim 12, wherein a low-power synchronization signal (SS) is repeated in a plurality of the one or more frequency sub-bands.

17. The UE of claim 12, wherein a codepoint corresponding to each of the one or more subgroups is repeatedly received in each of the one or more frequency sub-bands.

18. The UE of claim 12, wherein a codepoint corresponding to each of the one or more subgroups is received in one of the one or more frequency sub-bands.

19. The UE of claim 18, wherein the at least one processor is configured to perform frequency synchronization to detect the codepoint for each of the one or more subgroups.

20. A method of a user equipment (UE), comprising:
receiving a configuration message for low-power wake-up signal (WUS), wherein the configuration message indicates one or more frequency sub-bands associated with transmission of low-power WUS, one or more subgroups within the one or more frequency sub-bands for transmission of low-power WUS, or a combination thereof; and
receiving a low-power WUS in accordance with the configuration message.
